(19) United States
(12) Patent Application Publication
(10) Pub. No.: US 2014/0352380 A1
(43) Pub. Date: Dec. 4, 2014

(54) DEWATERING OF PHOSPHATE PRECIPITATES

(71) Applicant: Gunnar Thelin, Loberod (SE)

(72) Inventor: Gunnar Thelin, Loberod (SE)

(73) Assignee: EKOBALANS FENIX AB, Lund (SE)

(21) Appl. No.: 14/350,792

(22) PCT Filed: Jul. 6, 2012
(86) PCT No.: PCT/SE2012/050810

§ 371 Date: Jul. 11, 2014

(30) Foreign Application Priority Data
Oct. 13, 2011 (SE) 1150952-8

(51) Int. Cl. F26B 5/08; C05B 7/00

(52) U.S. Cl. CPC F26B 5/08; C05B 7/00
USPC 71/36; 34/312; 428/402

(57) ABSTRACT

The present invention describes a process for the treatment of a precipitate starting material comprising magnesium ammonium phosphate, magnesium potassium phosphate or potassium phosphate, or any derivate thereof, or a mixture thereof, said process comprising dewatering of the precipitate starting material, wherein the dewatering is performed by use of a hydrocyclone followed by the removal of excess water by filtration, and wherein the product obtained is a powder product. Furthermore, the present invention also discloses a powder product comprising particles of magnesium ammonium phosphate and/or magnesium potassium phosphate, wherein at least 75% of the particles have a particle size of maximum 10 μm and wherein at least 50% of the particles have a particle size in the range of 4-10 μm.

### CROSS-REFERENCES TO RELATED APPLICATIONS

This is a U.S. national phase application of PCT/SE2012/050810, filed Jul. 6, 2012, which claims priority to Sweden Patent Application No. 1150952-8, filed Oct. 13, 2011 both of which are incorporated by reference herein in their entirety.

### FIELD OF INVENTION

The present invention relates to the dewatering of different kinds of phosphate precipitates, in particular to the dewatering of a precipitate starting material which is based on at least one substance of magnesium ammonium phosphate or magnesium potassium phosphate.

### BACKGROUND

There exist different technologies today how to dewater precipitates. In the industry involved in refining residues or residual products, e.g. sludge or digestion residues, it is e.g. known to dewater and separate a sludge and subsequently precipitate different substances for use as fertilizer additives.

For instance in KR 2003/0034299 there is disclosed an apparatus for continuous crystallization of struvite (magnesium ammonium phosphate). The apparatus which comprises a struvite crystallizer is said to efficiently treat wastewater containing high concentration of nitrogen and phosphorus and toxic compounds by crystallizing phosphorus and nitrogen in wastewater into struvite crystals, thus alleviating loads on subsequent biological treatment.

Likewise, in US 2005/0023220 there is disclosed a struvite crystallization method and apparatus for the removal of phosphorus from phosphorus containing waste. The method is preferably carried out by contacting the phosphorus containing waste with a non-cellular membrane and precipitating phosphorus from the waste as struvite. The removal of phosphorus as struvite occurs in two stages as primary and secondary removal. In the primary removal process, the sewage from a dewatering unit is contacted with a first polymeric membrane reactor and the phosphorus is removed as primary struvite. Subsequently Mg is added so as promote struvite formation and the secondary removal process of struvite. In the secondary removal process, the sewage from GBT Filtrate well or Centrifuge Liquor well is contacted with a second monomolecular membrane and the phosphorus is removed as secondary struvite. Moreover, the centrifuge mentioned in US 2005/0023220 may be one choice of dewatering unit used for concentrating, before the actual struvite crystallization, however it is not used as a production unit for obtaining a powder.

Likewise, in EP 1041058, there is also mentioned the use of a centrifuge for the separation of struvite and other solid material from a liquid fraction. In this case, the centrifuge is used as a separator, however, not as a unit for the production of a powder product. Furthermore, the solid product obtained after the centrifugation in EP 1041058 is a mixture of different solids, obtained after the processing of pig manure by sterilization, addition of salts, precipitation and thereafter addition of a suitable organic flocculant, and hence, is not a powder product obtained after the dewatering of a precipitate starting material.

Moreover, in CN 101100398 there is disclosed a method for preparing ammonium magnesium phosphate monohydrate by putting monohydrate ammonium magnesium phosphate, magnesium hydrate and mono-ammonium phosphate into a reactor, then adding water, heating and agitating to generate ammonium-magnesium phosphate hexahydrate. Separation is made by centrifugation while depositing, then drying by hot air. Moreover, in JP 2005246215 there is disclosed a method for treating a sludge containing phosphorus and nitrogen, comprising a first process for performing a wet oxidation treatment, and a second process for producing a precipitate including magnesium ammonium phosphate (struvite) after adding magnesium ions to an alkaline solubilizing liquid, and a third process for separation, for instance performed by use of centrifugal concentration, a floatation, screen isolation separation, membrane separation or natural sedimentation. Drying may be performed subsequently. Likewise, in U.S. Pat. No. 3,195,978 there is disclosed that potassium precipitated from sea water as magnesium potassium phosphate can be recovered there from as an aqueous solution. Separation is said to be able to be performed by known manners, such as by filtering, decanting or by centrifugation. Filtration is said to be preferred. Drying may be performed subsequently, such as in hot air. Moreover, in U.S. Pat. No. 6,274,105 there is disclosed a process for the production of potassium phosphate, said process involving ion exchange, neutralization, concentration and crystallization, and also subsequent drying of the potassium salt.

In US 2010/0035308 there is disclosed the preparation of a fertilizer, including converting ammonium in an amino acid fermentation by-product liquor to magnesium ammonium phosphate. The method may involve granulation and drying, the latter being performed by e.g. a drum dryer, a fluid bed dryer, a belt dryer, a disc dryer, a flush dryer, a rotary dryer, a rotary vacuum dryer, a steam tube dryer, a tray dryer, a turbo dryer, a vacuum dryer or a conical dryer. Furthermore, in U.S. Pat. No. 6,464,875 there is disclosed a method for converting animal, vegetable, and food by-product materials into useful bio-gas and fertilizer. Struvite may be produced in the process. A centrifuge may be used in the process and drying may be involved in the process concept. Moreover, in WO 2011/110212 there are disclosed compositions in the form of a divided solid including hemipotassium phosphate (HKP). Also in this case a centrifuge may be used and drying may be involved in the process.

The present invention is directed to the dewatering of different kinds of phosphate precipitates, such as struvite, and aims as to provide an improved method for performing such dewatering.

### SUMMARY OF THE INVENTION

The stated purpose above is achieved by a process for the treatment of a precipitate starting material to produce a first final product, said process comprising dewatering of the precipitate starting material, wherein the precipitate starting material is a precipitate based on at least one substance of a magnesium ammonium phosphate, a magnesium potassium phosphate or a potassium phosphate, or any derivate thereof, or a mixture thereof, wherein the dewatering is performed by use of a hydrocyclone followed by the removal of excess water by filtration, and wherein the first final product is a powder product.

Usage of hydrocyclones or filters is performed today. For instance, in JP 2004160340 there is disclosed an organic waste water or sludge treatment system for the separation/recovery of magnesium ammonium phosphate (MAP; struvite) and calcium phosphate (HAP) from the waste water and sludge. The separation may be performed by treatment with a mesh-shaped or slit-shaped shifter, separation treatment with a hydrocyclone, and separation treatment with a drum rotation type fine particle separation apparatus having a mechanism where an objective liquid is introduced into a rotator with a horizontal cylindrical shape, and centrifugal force by rotation and oscillation in a rotating shaft direction are applied thereto, and a mechanism capable of optionally controlling the tilt of the rotator, so that the fine particles are separated/recovered.

Furthermore, in KR 2003/0034299 there is disclosed an apparatus for continuous struvite crystallization (magnesium ammonium phosphate: MgNH₄PO₄). The apparatus for continuous struvite crystallization comprises a vertical inlet (1) through which raw wastewater, together with air, Mg, PO₄ and alkali agent, is supplied into the apparatus; a struvite crystallizer (2) in which nitrogen and phosphorus in raw wastewater precipitates into struvite; a hydrocyclone (4) in which a propeller (3) is installed to cause centrifugal force for solid/liquid separation; an overflow (5) through which struvite crystals are settled downward; a struvite crystal inlet (7) through which a portion of struvite crystals is introduced into the struvite crystallizer to act as crystallization nuclei; a sludge hopper (8); a struvite crystal drain (9); a weir (10) over which supernatant after solid/liquid separation is discharged; and an air vent (11) through which air supplied from the vertical inlet exits to atmosphere.

Moreover, EP 0530826 relates to a process for the simultaneous ammonium precipitation and dewatering of liquid sludge by treating the sludge with precipitation additives, characterized in that the sludge is conditioned by direct addition of a precipitation additive containing one or more magnesium compounds as well as optionally one or more phosphates to precipitate ammonium contents in the form of magnesium ammonium phosphate and that the so conditioned sludge is dewatered on a dewatering device to form a filtrate having a decreased nutrient load, the filtrate being passed into a sewage works and the dewatered sludge having an increased nutrient load being removed. The dewatering device may be a chamber filter press, a vacuum filter, a sieve, ribbon press, a centrifuge or a hydrocyclone.

Furthermore, U.S. Pat. No. 7,264,715 discloses a process and an apparatus for recovering magnesium ammonium phosphate (MAP) crystals in the technique of removing phosphorus and the like as MAP crystals from wastewater containing high concentration organic substance, phosphorus and nitrogen. The sludge mixed liquor containing MAP crystal particles is treated by an MAP recovery device, such as a hydrocyclone to separate and recover the formed MAP crystal particles. The sludge mixed liquor after separation of the MAP crystal particles is introduced into a dehydrator to recover the suspended solids content as the dehydrated cake. The separated water obtained in the dehydrator is introduced into a second crystallization tank, added with a magnesium source and a pH adjustor, and mixed to form and recover MAP particles again. The supernatant liquor after recovery of the MAP particles can be returned to the primary sedimentation tank.

Furthermore, in U.S. Pat. No. 7,431,834 there is shown a system for separating crystals from sludge, or from separated water generated when sludge is subjected to a concentration process or a dewatering process, where MAP (magnesium ammonium phosphate) can be recovered. As a method of separating the micro-particles from the digested sludge using the specific gravity difference between the two, the system may employ a hydrocyclone, a centrifugal settler, a sedimentation tank employing gravity separation, and as a method for micro-particle separation using differences in particle diameter, a vibrating screen, a drum screen, a filter layer, a classification layer-type separation tank, and so on may be employed.

The present invention is directed to the specific combination of using at least one hydrocyclone and thereafter performing filtration for taking care of excess water. This processing and the advantages thereof have not been presented above in the cited documents.

According to the present invention, the hydrocyclone separates the particles, such as struvite particles, from water into a thick slurry with 20-40% d.s. The slurry is emptied directly into a bigbag (see below) which acts as both filter and material collector. Water from the slurry is spontaneously and effectively pushed out from the struvite particles mass and leaches through the bigbag fabric leaving behind a struvite mass with >50% d.s. Therefore, according to one specific embodiment of the present invention, the filtration is performed in a bag made of fabric and wherein the filtration is driven by gravity and where excess water penetrates the fabric and leaves the powder product in the bag. The final powder product is as such effectively dewatered in the actual storage container. According to one specific embodiment, the excess water is captured in a vessel after the filtration. The bag may be put on a pan or the like, excess water penetrated the fabric of the bag and then flows down into the vessel. The excess water may be reused or recirculated into another process step.

It should be noted that the use of the expression “first final product” implies that the final product obtained may be subsequently processed, so as to obtain a “second final product”, or even further to a “third final product”, etc.

As may be understood from above, the precipitate starting material may be any of a magnesium ammonium phosphate, a magnesium potassium phosphate or a potassium phosphate, or a derivate thereof, or a mixture thereof, however, a magnesium ammonium phosphate or a magnesium potassium phosphate, or derivates thereof, or combinations thereof are most interesting in relation to the present invention. As discussed below, struvite is one very interesting precipitate starting material in relation to the present invention.

As disclosed above, it is known to dewater struvite by use of crystallization and equipment therefore. The solid struvite precipitate may for instance be removed from water by first performing a crystallization in one or more reactors so that crystals of e.g. 1-2 mm size are obtained, and then filter off such crystals.

The present invention is not directed to achieving such large precipitate crystals. According to the present invention the dewatering is performed by hydrocyclone plus filtration so that a powder product is obtained, e.g. a struvite powder. Such a powder has several advantages in comparison to larger crystals. Firstly, the powder is much easier to mix with other products in subsequent steps. In case of large crystals, such have to be crushed before being mixed with other components. The powder according to the present invention, however, may easily be homogenously mixed with other substances. Secondly, the powder is also easier to process further if intended. One such example is subsequent agglomeration, where the powder according to the present invention gives the possibility to control the final particle hardness, which is not possible to control with large crystals. Finally, it should also be mentioned that the process according to the present invention is possible to perform without the need of advanced equipment such as large reactors, e.g. crystallizers according to KR 2003/0034299.

As mentioned above, the process according to the present invention involves hydrocyclone separation plus filtration. The important concept feature of the present invention is to process the dewatering so that a powder product is obtained, either as a final product or a product which is processed further. This is an important difference in relation to known dewatering processes.

### BRIEF DESCRIPTION OF THE DRAWINGS

FIG. 1 shows the normal distribution curve of the particle size of one batch of a powder produced according to the present invention.

### DETAILED DESCRIPTION OF THE PREFERRED EMBODIMENTS

Below, specific embodiments of the present invention are described. According to one embodiment, the process according to the present invention is a partial process involved in the refining of residues. As disclosed above, such residues may be sludge or digestion residues. The process according to the present invention may be a partial process in the refining of such residues for the production of fertilizers. In such refining it is known to dewater and capture and refine different nutrients, such as nutrients comprising phosphorous and nitrogen, respectively. The refining of phosphorous and nitrogen is often performed in different steps. The process of the present invention may be used as a partial process after the precipitation of phosphorus, and as a step before the nitrogen refining, in such processes.

The dry matter level obtained during the dewatering process is of interest. According to one specific embodiment of the present invention, the de-watering processing in the hydrocyclone and subsequent filtration is performed to a dry matter level of at least 40%, such as in the range of 40-60%, preferably e.g. 60% or higher. Such a dry matter level contributes to the elimination of transportation of much water before the drying. For instance, the stated dry matter level renders a reject (liquid phase) having a high nitrogen level which is intended to be recovered in another separate process step.

According to one specific embodiment of the present invention, the dewatering process also comprises additional steps. One such possible subsequent step is drying, e.g. performed in a maximum temperature of 50° C. This temperature maximum may be of importance to avoid the release of nitrogen during the drying, and still render a dry product after drying. When the dewatering is performed as according to the present invention, i.e. to a high level of dry matter, a subsequent drying step may be easy to perform. For instance, when the dry matter level of the dewatering is performed to a range of 40-60%, preferably e.g. at least 60%, a subsequent drying and the equipment therefore may be simple.

According to one specific embodiment of the present invention, a subsequent drying is performed. According to one embodiment of the present invention, the subsequent drying is performed in a maximum temperature of 50° C. According to yet another specific embodiment, the subsequent drying is performed by air drying or by vacuum drying. Furthermore, according to one embodiment the subsequent drying is performed in a rotation drum provided with warm air flowing through.

Trials have been performed to evaluate the influence of the temperature during the drying. A struvite precipitation starting material was used. 4-5 grams of the starting material was heated at 25° C., 50° C. and 75° C., respectively, in an oven, for three different trials. The samples were weighted every hour during the first 7 hours and were then weighted one more after 24 hours.

The trial made at 75° C. showed a very different result in comparison with the trials made at 25° C. and 50° C. The mass was reduced almost 50% at 75° C., while only below 5% at 25° C. and 50° C. The smell of ammonia was much stronger at 75° C. than at 25° C. or 50° C. when the oven was opened during the beginning of the trials. In concentrated struvite, the mass of NH₄ is about 7.4 mass % and the content of H₂O is 44 mass %. Hence, the reduction of the mass in the trial at 75° C. may be explained by release or loss of ammonia and crystal water.

As may be understood from above and as an example, a possible additional subsequent drying may be performed in air drying at about room temperature (20-25° C.). At such low temperatures in comparison for air drying, a good air supply is needed and a sufficient retention time. Such conditions may for instance be obtained in a rotation drum provided with warm air flowing through the rotation drum. Drying temperatures between 20° C. and 50° C. are of course also possible according to the present invention.

As mentioned above, struvite is one important possible substance to use according to the present invention. Therefore, according to one specific embodiment, the precipitate starting material is a precipitate based on struvite (ammonium magnesium phosphate, formula ((NH₄)MgPO₄·6H₂O)).

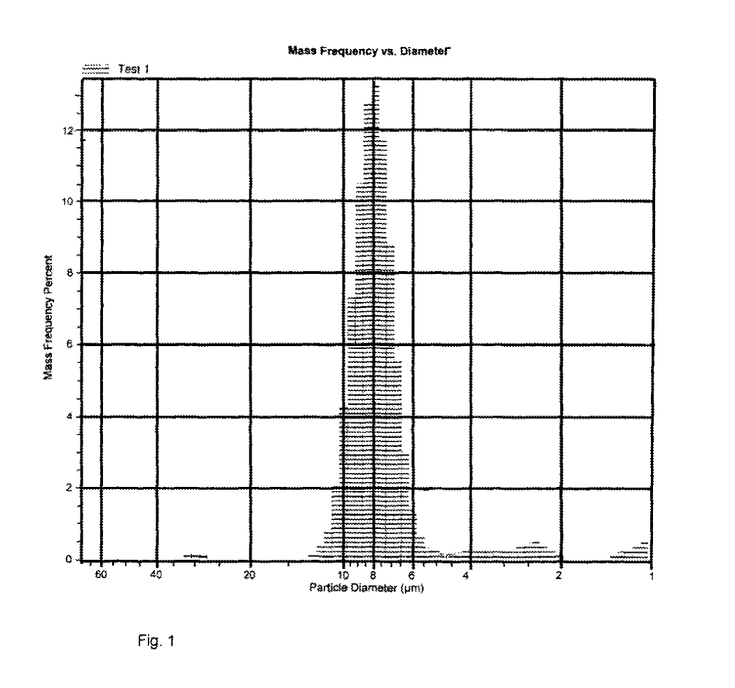

As said above, the product achieved by the present invention is a powder product. One of the important differences between a powder product and crystals are the physical shapes and sizes. These differences imply advantages for a powder, such as the ones disclosed above, i.e. being easy to mix homogenously with other raw products and being easy to agglomerate as it is or as a mixed product. The particle size of the particles in the powder is one feature that may define the powder. According to a first aspect of the powder product according to the present invention, the powder product comprises magnesium ammonium phosphate particles and/or magnesium potassium phosphate particles where at least 75% of the particles have a particle size of maximum 10 μm and wherein at least 50% of the particles have a particle size in the range of 4-10 μm. Such a distribution may be seen in FIG. 1 for magnesium ammonium phosphate (struvite) particles. According to yet another specific embodiment, the powder product comprises magnesium ammonium phosphate particles and/or magnesium potassium phosphate particles where at least 90% of the particles have a size of maximum 10 μm. According to another embodiment of the present invention, the powder product comprises magnesium ammonium phosphate particles and/or magnesium potassium phosphate particles, where at least 70% of the particles have a particle size in the range of 4-10 μm.

As shortly said above, the powder product obtained by the process according to the present invention, may be further processed. One example is by agglomeration. In this case, one can say that a second final product is obtained after the agglomeration. Furthermore, it is important to realize that the agglomeration may be performed at a different plant, but of course also in the same plant as the dewatering process of the present invention. Moreover, the agglomeration may be performed on a mixture comprising the powder product as well as at least one other nutrient, e.g. ammonium sulphate and/or potassium chloride. Ammonium sulphate may e.g. be obtained in another separate process step, but may then be mixed together with the powder of the present invention before agglomeration.

As mentioned above, the powder product according to the present invention has several advantages for such subsequent agglomeration. The powder is easily homogenously mixed with other components, such as nutrients, and the particle hardness is possible to control in the agglomeration. This is not possible with large crystals. For instance, a struvite powder obtained by the process according to the present invention may be mixed with a nutrient before agglomeration. The particle hardness of the final product after agglomeration is possible to control. Such handling would not be possible if large struvite crystals were used, which firstly would have to be crushed. It should, however, also be mentioned that large struvite crystals are not intended for such use.

The invention is also directed to the powder product obtainable by the process according to the present invention. According to one specific embodiment, the present invention embodies a powder comprising particles of magnesium ammonium phosphate and/or magnesium potassium phosphate, or derivates thereof, or mixtures thereof, wherein at least 75% of the particles have a particle size of maximum 10 μm and wherein at least 50% of the particles have a particle size in the range of 4-10 μm.

Magnesium ammonium phosphate and magnesium potassium phosphate are chemicals which are known in granular form. For example in U.S. Pat. No. 6,506,805 there is disclosed a magnesium ammonium phosphate slurry and a method of producing magnesium ammonium phosphate slurries, wherein the obtained magnesium ammonium phosphate hexahydrate slurry is said to have a small particle size of about 2 to 7 microns. The slurry produced according to U.S. Pat. No. 6,506,805 is not a powder product, but in fact a slurry. One of the fundaments of the present invention is to produce a dry product and not a slurry. Nevertheless, it should be mentioned that it is stated in U.S. Pat. No. 6,506,805 that all known slurries of magnesium ammonium phosphate have a particle size of at least about 10 microns or larger.

Furthermore, in U.S. Pat. No. 7,264,715, there is disclosed a process and an apparatus for efficiently recovering magnesium ammonium phosphate (MAP) crystals of high purity from wastewater. According to one aspect, magnesium ammonium phosphate particle having a particle diameter of 100 micrometer or less is separated from the sludge mixed liquor. Once again, U.S. Pat. No. 7,264,715 is related to sludge (slurry) treatment, and not to powder production. Furthermore, the finest grains disclosed according to U.S. Pat. No. 7,264,715 are not 10 μm or less. Moreover, U.S. Pat. No. 7,264,715 is related to large crystals and not particles.

Moreover, in DE 1592810 there is disclosed an agglomerated/granulated fertilizer product. The product may comprise magnesium potassium phosphate with primary particles having a size of less than about 100 μm, preferably a size range of 10-60 μm. The distribution disclosed in DE 1592810 is not a distribution where at least 75% of the particles have a particle size of maximum 10 μm and wherein at least 50% of the particles have a particle size in the range of 4-10 μm. The distribution in DE 1592810 is related to larger crystals as the ones discussed above, and not small particles giving a powder according to the present invention.

Moreover, US 2003/0056913 is related to methods of producing magnesium ammonium phosphate (struvite) in monohydrate form (dittmarite), and in particular to methods of converting a hexahydrate form of magnesium ammonium phosphate (struvite) into a monohydrate form of magnesium ammonium phosphate monohydrate (dittmarite). The struvite slurry hexahydrate magnesium ammonium phosphate is said to be obtained by any known processes of reacting magnesium hydroxide, ammonia, phosphoric acid and water. The method is said to be effective in converting such slurry of hexahydrate form to the monohydrate form of magnesium ammonium phosphate usable to form filler for paper making, wherein a particle size is preferably in the range of approximately from 2 μm to 8 μm, more preferably in the range of from 2 μm to 4 μm. The slurry may be dried to particle form. Although it is mentioned that the slurry may be dried, US 2003/0056913 does not disclose a powder product where at least 75% of the particles have a particle size of maximum 10 μm and wherein at least 50% of the particles have a particle size in the range of 4-10 μm. The particles obtained according to US 2003/0056913 are in fact smaller than the optimal range according to the present invention. If viewing the distribution curve in FIG. 1 it is obvious that a very small fraction, such as less than 15%, even less than 10% of the particles have a size of below 4 μm. This is not the intended range according to US 2003/0056913. Furthermore, US 2003/0056913 are also related to handling of slurries differently than according to the present invention. Although it is mentioned that the slurries may be dried to a particle form this is said to be performed with flash drying under elevated temperatures. This is not intended according to the present invention and the handling of the powder is much more lenient than the handling according to US 2003/0056913.

According to one specific embodiment of the present invention, at least 95%, such as at least 98%, of the particles have a particle size of maximum 10 μm. According to another specific embodiment, at least 70%, such as at least 75% or even at least 80%, of the particles have a particle size in the range of 4-10 μm. According to yet another specific embodiment, less than 15%, such as less than 10%, of the particles have a particle size of below 4 μm. Such embodiments are further shown from the normal distribution curve shown in FIG. 1.

As hinted above, a powder comprising struvite particles is one preferred powder according to the present invention.

The present invention also embodies a mixture comprising a powder according to the present invention and at least one other nutrient, such as ammonium sulphate or a potassium salt, or a combination thereof. The potassium salt may e.g. be potassium chloride. Furthermore, the present invention also embodies an agglomerate comprising an agglomerated powder or mixture according to the present invention.

Furthermore, the present invention also embodies the use of a precipitate starting material being a precipitate based on at least one substance of a magnesium ammonium phosphate, a magnesium potassium phosphate or a potassium phosphate, or a derivate thereof, or a mixture thereof, for the de-watering of the precipitate starting material to obtain a first final product being a powder product, wherein the precipitate starting material is processed by use of a hydrocyclone followed by the removal of excess water by filtration. Also in this case magnesium ammonium phosphate or magnesium potassium phosphate are very interesting examples, especially struvite based precipitate starting material. Specific embodiments disclosed above in relation to the process of the present invention, are also valid in relation to the use of the present invention.

### Detailed Description of the Drawing

In FIG. 1 there is shown a normal distribution curve of the particle size for a powder product according to the present invention. In this specific case, the powder is based on struvite particles entirely. From the curve it may noted that at least 98% of the particles have a particle size of maximum 10 μm according to this particle batch of the present invention. Furthermore, at least 80% of the particles have a particle size in the range of 4-10 μm in this batch. Moreover, less than 10% of the particles have a size of below 4 μm.

I claim:

1. Process for the treatment of a precipitate starting material to produce a first final product, said process comprising dewatering of the precipitate starting material, wherein the precipitate starting material is a precipitate based on at least one substance of a magnesium ammonium phosphate, a magnesium potassium phosphate or a potassium phosphate, or any derivate thereof, or a mixture thereof, wherein the dewatering is performed by use of a hydrocyclone followed by the removal of excess water by filtration, and wherein the first final product is a powder product.

2. Process according to claim 1, wherein the filtration is performed in a bag made of fabric and wherein the filtration is driven by gravity and where excess water penetrates the fabric and leaves the powder product in the bag.

3. Process according to claim 1, wherein the excess water is captured in a vessel after the filtration.

4. Process according to claim 1, wherein said process is a partial process involved in the refining of residues.

5. Process according to claim 1, wherein the dewatering is performed to a dry matter level of at least 40%.

6. Process according to claim 1, wherein a subsequent drying is performed.

7. Process according to claim 6, wherein the subsequent drying is performed in a maximum temperature of 50° C.

8. Process according to claim 6, wherein the subsequent drying is performed by air drying or by vacuum drying.

9. Process according to claim 6, wherein the subsequent drying is performed in a rotation drum provided with warm air flowing through.

10. Process according to claim 1, wherein the precipitate starting material is a precipitate based on struvite (ammonium magnesium phosphate, formula ((NH₄)MgPO₄·6H₂O)).

11. Process according to claim 1, wherein the powder product comprises magnesium ammonium phosphate particles and/or magnesium potassium phosphate particles where at least 90% of the particles have a size of maximum 10 μm.

12. Process according to claim 1, wherein the powder product comprises magnesium ammonium phosphate particles and/or magnesium potassium phosphate particles, where at least 70% of the particles have a particle size in the range of 4-10 μm.

13. Process according to claim 1, wherein the powder product subsequently is agglomerated.

14. Process according to claim 13, wherein the powder product subsequently is agglomerated together with other nutrients.

15. Use of a precipitate starting material being a precipitate based on at least one substance of a magnesium ammonium phosphate, a magnesium potassium phosphate or a potassium phosphate, or a derivate thereof, or a mixture thereof, for the dewatering of the precipitate starting material to obtain a first final product being a powder product, wherein the precipitate starting material is processed by use of a hydrocyclone followed by the removal of excess water by filtration.

16. Powder comprising particles of magnesium ammonium phosphate and/or magnesium potassium phosphate, or derivates thereof, or mixtures thereof, wherein at least 75% of the particles have a particle size of maximum 10 μm and wherein at least 50% of the particles have a particle size in the range of 4-10 μm.

17. Powder according to claim 16, wherein at least 95% of the particles have a particle size of maximum 10 μm.

18. Powder according to claim 16, wherein at least 70% of the particles have a particle size in the range of 4-10 μm.

19. Powder according to claim 16, wherein the particles are struvite particles.

20. Mixture comprising a powder according to claim 16 and at least one other nutrient.

21. Mixture according to claim 20, wherein the at least one other nutrient is ammonium sulphate or a potassium salt, or a combination thereof.

22. Agglomerate comprising an agglomerated powder according to claim 16 or an agglomerated mixture according to claim 20.
